(19) United States
(12) Patent Application Publication
(10) Pub. No.: US 2015/0024836 A1
(43) Pub. Date: Jan. 22, 2015

(54) METHOD AND APPARATUS FOR AWARDING A JACKPOT

(71) Applicant: Paltronics Australasia Pty Limited, Taren Point (AU)

(72) Inventors: DEAN WRIGHT, TAREN POINT (AU); ALAN MINSKI, TAREN POINT (AU); ALI JOMAA, TAREN POINT (AU)

(21) Appl. No.: 14/505,884

(22) Filed: Oct. 3, 2014

Related U.S. Application Data
(63) Continuation-in-part of application No. 13/752,828, filed on Jan. 29, 2013.

(30) Foreign Application Priority Data
Jan. 30, 2012 (AU) 2012200553
Oct. 4, 2013 (AU) 2013237737

(51) Int. Cl. G07F 17/32

(52) U.S. Cl. CPC G07F 17/3258
USPC 463/26

(57) ABSTRACT

The preferred method of awarding a jackpot includes the step 10 of initialising a variable representing the jackpot amount and the step 11 of initialising a variable representing a lump sum. At step 12 a signal including data indicative of gaming activity is received by the controller 2, which calculates first and second increments in dependence upon said data at steps 13 and 14. The jackpot amount is incremented by the first increment at step 13 and, in response to a trigger, the jackpot amount is incremented by the lump sum at step 16. When an award of the jackpot is triggered at step 18, the CPU executes an allocation routine 19 to determine the EGM to which to award the jackpot.

### FIELD OF THE INVENTION

The present invention relates to a method and apparatus for awarding a jackpot. Embodiments of the present invention find application, though not exclusively, in the gaming industry for use with linked networks of electronic gaming machines.

### BACKGROUND OF THE INVENTION

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

It is known to link a number of electronic gaming machines to form a network. Such networks may be linked to a controller, such as a server, to provide a secondary game such as a jackpot game in which each of the linked electronic gaming machines may participate. This secondary game is typically provided in addition to the primary game of the electronic gaming machines, which may for example be slots, poker, blackjack, bingo, keno, or the like. The players of the linked electronic gaming machines each contribute to, and may win, a jackpot prize.

It has been appreciated by the inventors of the present application that variations to the manner in which the jackpot amount is accrued, or at least to the manner in which the jackpot amount is communicated to the players during its accrual, may contribute to increased player anticipation and excitement. This may be particularly so if the variations contribute to greater volatility, randomness and/or unpredictability.

### SUMMARY OF THE INVENTION

It is an object of the present invention to overcome, or substantially ameliorate, one or more of the disadvantages of the prior art, or to provide a useful alternative.

According to a first aspect of the present invention there is provided a method of awarding a jackpot in a gaming system in which a jackpot controller is communicatively coupled to a plurality of electronic gaming machines (EGMs), said method including the use of the jackpot controller to:

initialise a variable representing a jackpot amount;

initialise a variable representing a lump sum;

receive a signal including data indicative of gaming activity associated with at least one of the electronic gaming machines;

calculate a first increment in dependence upon said data and increment the variable representing the jackpot amount by the first increment;

calculate a second increment in dependence upon said data and increment the variable representing the lump sum by the second increment;

in response to a trigger that is independent of an award of the jackpot increment the variable representing the jackpot amount by the lump sum; and

determine if an award of the jackpot has been triggered and, if so, execute an allocation routine to determine an EGM to which to award the jackpot.

Preferably an award of the jackpot is triggered when the jackpot amount equals or exceeds a jackpot threshold amount. Preferably the jackpot threshold amount cannot exceed a maximum jackpot amount.

In one embodiment each of the electronic gaming machines has a unique identifier and the step of receiving “a signal including data indicative of gaming activity associated with at least one of the electronic gaming machines” includes receiving the unique identifier of each EGM, along with a turnover amount of each of the EGM's within a polling period. This embodiment further includes the step of storing said EGM identifiers and said turnover amounts within a memory accessible by the jackpot controller.

In one embodiment the allocation routine awards the jackpot amount to the EGM that contributed the portion of an increment that incremented the jackpot amount to at or above the jackpot threshold amount.

In another embodiment the allocation routine includes the steps of:

calculating a new jackpot threshold amount that lies within a range defined by the current jackpot amount and the maximum jackpot amount;

continuing to increment the jackpot amount based on said data indicative of gaming activity; and

awarding the new jackpot threshold amount to the EGM that contributed the portion of an increment that incremented the jackpot amount to at or above the new jackpot threshold amount.

In another embodiment the allocation routine awards the jackpot to the last EGM that contributed a portion of an increment immediately prior to the triggering of the award of the jackpot amount.

In yet another embodiment the allocation routine awards the jackpot to the next EGM to make a contribution subsequent to the triggering of the award of the jackpot.

Preferably the awarding of the jackpot includes the steps of:

subtracting the jackpot threshold amount from the jackpot amount and storing the result as a remainder amount;

awarding the jackpot threshold amount to an EGM; and

calculating a start out amount by incrementing a base start up amount by the remainder; and

commencing accumulating a new jackpot amount from the start out amount.

According to another aspect of the present invention there is provided a jackpot controller communicatively coupled to a plurality of electronic gaming machines, said jackpot controller being configured so as to perform a method as described above.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

FIG. 1 is a schematic representation of an embodiment of the present invention;

FIG. 2 is a flowchart showing steps performed in an embodiment of the inventive method;

FIG. 3 is a table of amounts as calculated for an example implementation of a preferred embodiment for each of 50 polling periods, the information including: turnover; first increments; second increments; lump sums and jackpot amounts; and

FIG. 4 is a graph showing the example accumulated jackpot amounts for each of the 50 polling periods of FIG. 3.

### DETAILED DESCRIPTION OF PREFERRED EMBODIMENTS OF THE INVENTION

Some embodiments of the invention make use of certain elements of hardware and software similar to that disclosed in Patent Application No. PCT/AU2004/000964, the disclosure of which is incorporated herein by way of reference.

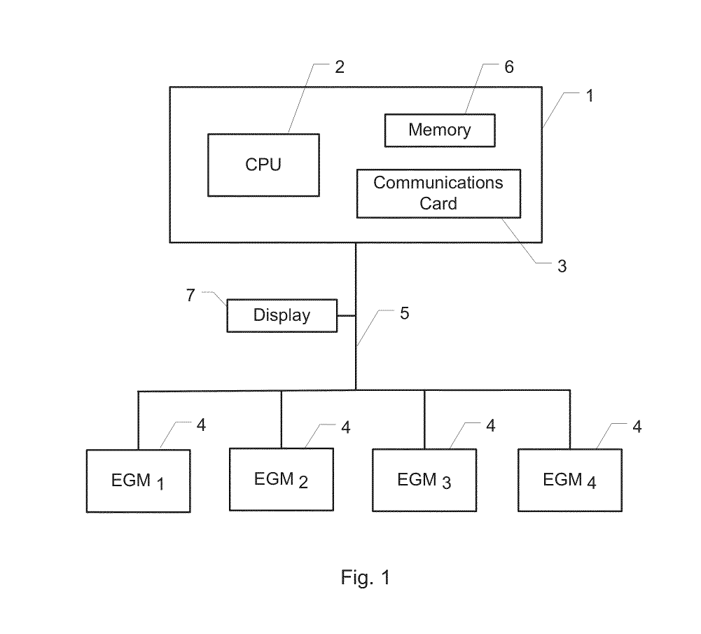

Referring to FIG. 1, the controller 1 has a processor in the form of a central processing unit (CPU) 2 and a communications card 3 that is operatively coupled to the CPU 2 and which communicatively links the controller 1 to a plurality of electronic gaming machines (EGM's) 4. In some embodiments the communications link 5 is provided by cables, a wireless link, a local area network, a wide area network, or a combination thereof. The EGM's 4 may be located within a single establishment, or may be located in two or more geographically dispersed locations. Also operatively coupled to the CPU 2 is memory 6, which is typically in the form of random access memory or other readable and writable digital storage media such as hard drives, flash drives, and the like. The memory 6 includes a number of memory addresses, one of which is allocated to store a variable representing the current value of the jackpot amount and another of which is allocated to store a variable representing the current value of the lump sum.

In some embodiments the CPU 2 is programmed to perform the inventive method by means of computer executable code stored on a computer readable medium, such as a CD-ROM, for example. In other embodiments the executable code is accessed either by means of downloading a file from a remote location, for example via the internet, or by means of remote execution, such as in a so-called “cloud computing” context.

The CPU 2 has access to display driver software that is executable to cause the display 7 to display various messages to the players of the EGM's 4. In the illustrated embodiment the CPU is programmed to cause the display 7 to display the jackpot amount. Typically, one or more of the displays 7 are positioned such that they are viewable by all, or at least a majority of, the players of the EGM's 4 that are contributing to the linked jackpot for which the jackpot amount is being accumulated.

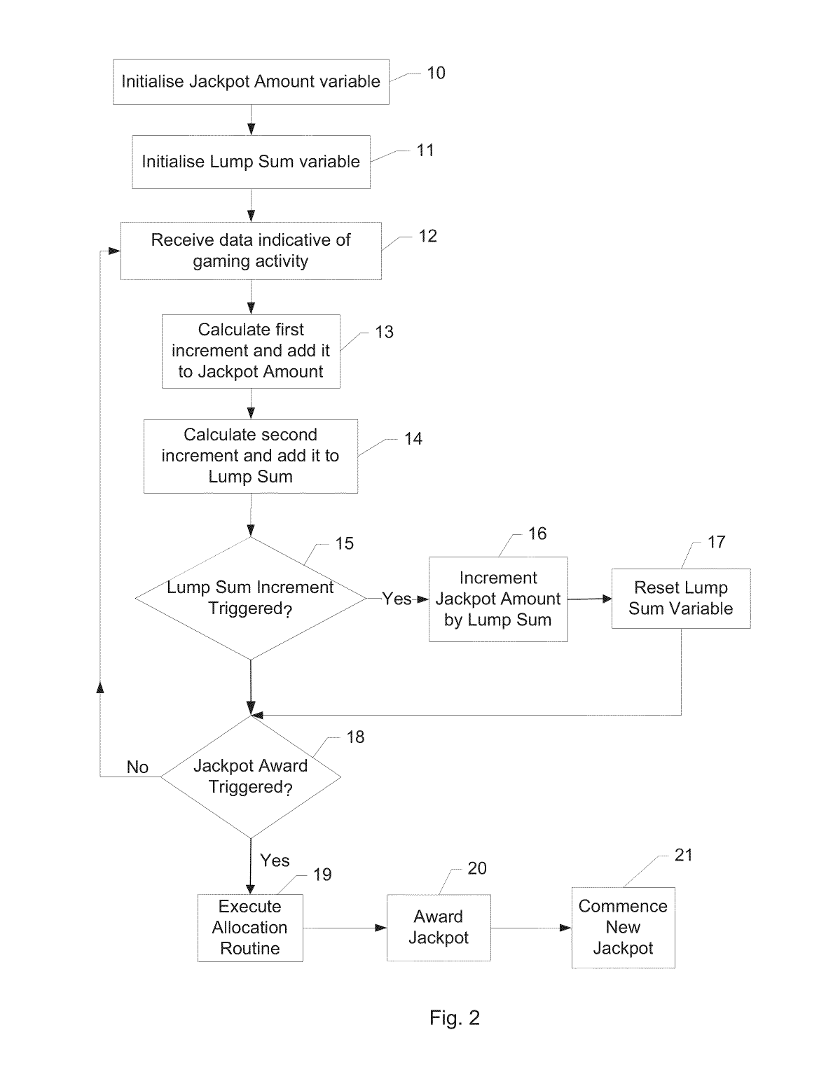

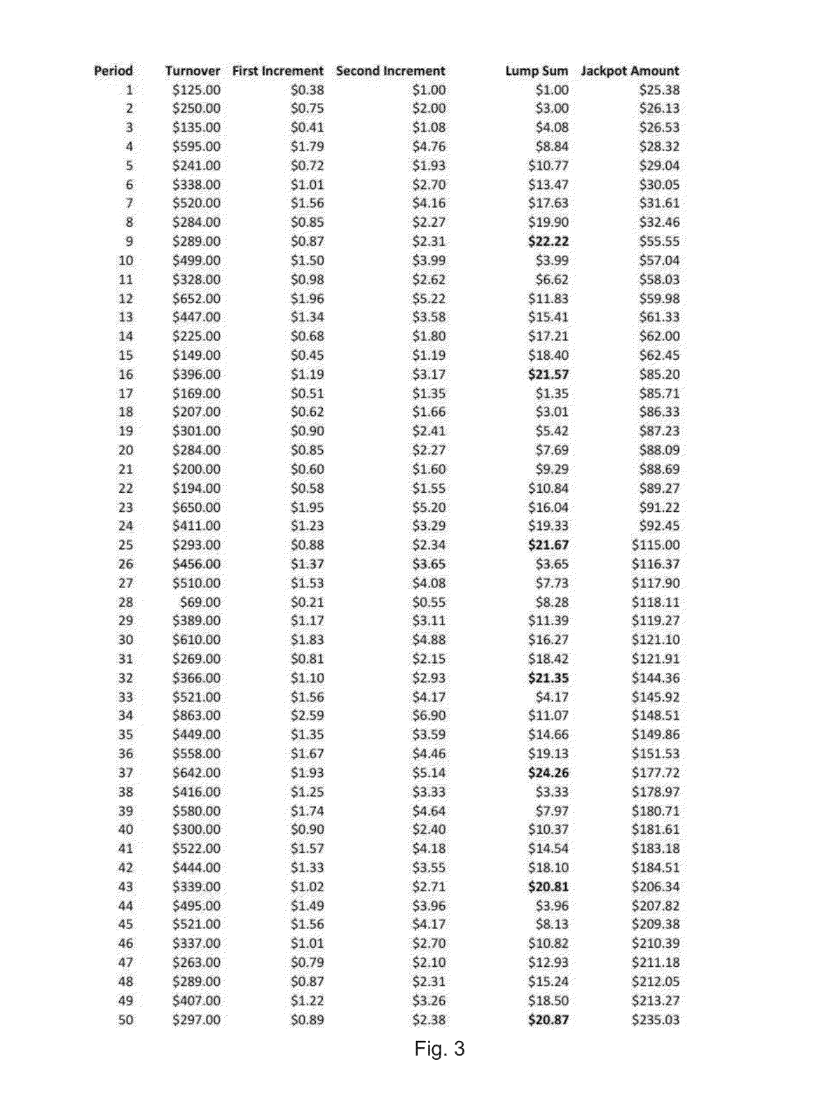

With reference to FIG. 2, the method of awarding a jackpot commences with the step 10 of initialising the variable representing the jackpot amount. By way of a non-limiting running example, the steps illustrated in FIG. 2 will be described with reference to the example amounts shown in FIG. 3. In this example implementation, the variable representing the jackpot amount is initialised to a start out value of $25.00 at the commencement of the jackpot immediately prior to polling period 1.

At step 11 the variable representing the lump sum is initialised to a start out value, which in the running example is $0.00.

At step 12 the CPU 2 ascertains a quantum of gaming activity. More particularly, the EGM's 4 with which the controller 1 is in communication are each programmed to send a signal to the controller 1 encoding data indicative of the EGM's unique identifier and the EGM's gaming activity. One such signal is sent per EGM 4 for each polling period and the data includes the turnover recorded by the EGM within the immediately preceding polling period. Each polling period extends for a predetermined length of time and FIG. 3 provides example amounts for each of 50 polling periods. As the signals are received by the controller 1, as shown at step 12 of FIG. 2, the data representing EGM unique identifiers and their respective turnover is extracted from the signal and stored in the memory 6. Once a turnover amount has been received for all of the participating EGM's 4, the CPU 2 of the controller 1 performs an addition of each of the individual turnover amounts to determine a global turnover amount for the relevant polling period and this global turnover figure is stored in memory 6. An example of such a global turnover amount for each of the polling periods is set out in the second column of FIG. 3. Hence, in the running example, the global turnover for polling period 1 is $125, the global turnover for polling period 2 is $250, and so forth.

The gaming activity as reported by each of the EGM's is stored in the memory 6. Hence, it is possible for the CPU to treat the stored gaming activity data as a historical record from which it is possible at a later point in time to determine the portions of each increment that were contributed by each of the EGM's.

At step 13 the CPU 2 calculates the first increment by multiplying the global turnover figure for the applicable polling period by a first multiple, which in the running example is 0.3%. This gives a first increment of $0.38 for the first polling period, a first increment of $0.75 for the second polling period, and so forth as set out in the third column of FIG. 3. The variable representing the jackpot amount is then incremented by the first increment, which results in a jackpot amount of $25.38 for polling period 1, a jackpot of $26.13 for polling period 2 and so forth as shown in the sixth column of FIG. 3. From a player's perspective, the jackpot amount is substantially continuously incremented by the first increments and the display 7 may be driven by the CPU 2 so as to display a substantially continuously increasing jackpot amount as the first increments are added to it.

At step 14 the CPU 2 calculates the second increment by multiplying the global turnover figure for the applicable polling period by a second multiple, which in the running example is 0.8%. This gives a second increment of $1.00 for the first polling period, a second increment of $2.00 for the second polling period, and so forth as set out in the fourth column of FIG. 3. The variable representing the lump sum is then incremented by the second increment, which results in a lump sum of $1.00 for polling period 1, a lump sum of $3.00 for polling period 2 and so forth as shown in the fifth column of FIG. 3.

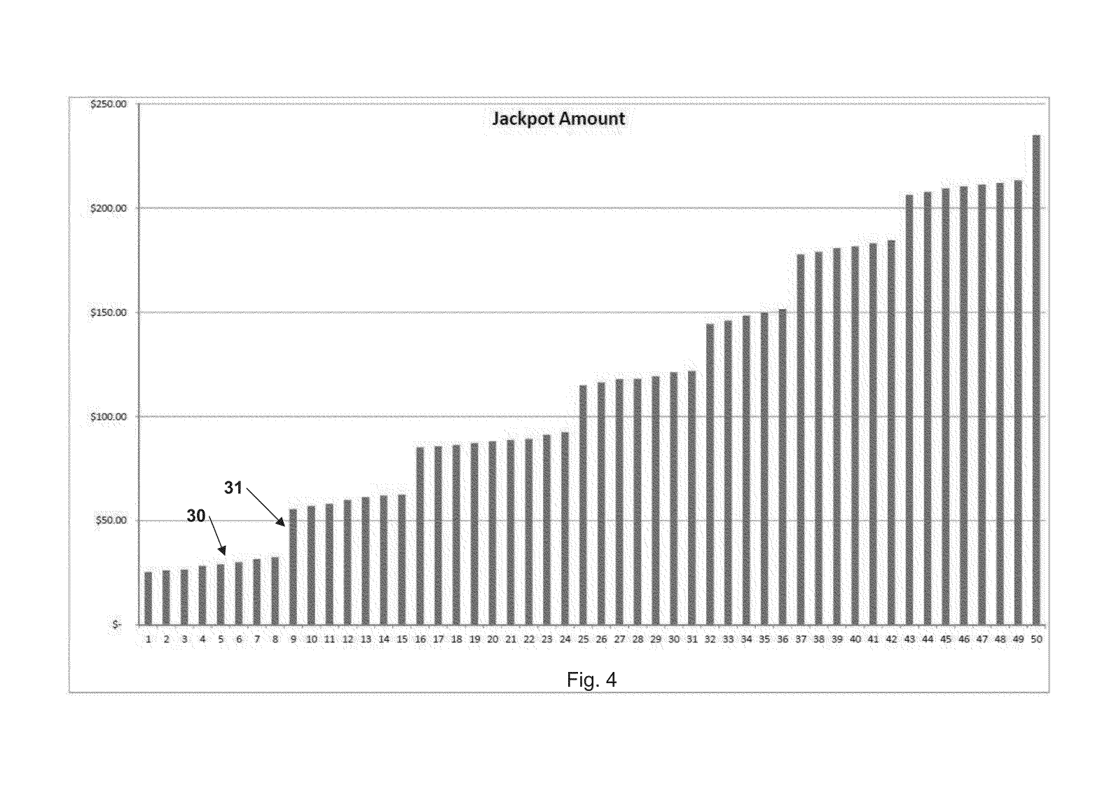

It can be seen that the lump sum grows steadily and progressively as each of the second increments of each of the first nine polling periods is added to it, culminating in this running example in a lump sum of $22.22 for polling period 9. During this period the jackpot amount also accumulates steadily and progressively. The first of these “steady and progressive” phases of jackpot accumulation is labeled 30 in the chart of FIG. 4. During the accumulation of the lump sum, the display 7 displays the jackpot amount to the players, but not the lump sum. Hence, during this period the players are likely to be unaware of the accumulation of the lump sum (other than, perhaps, suspecting that something extra is accruing due to having previously observed the jackpot accumulation method in action, or possibly being generally aware that something extra is accruing due to having read the rules of the linked jackpot game).

Various embodiments of the invention define various triggers for incrementing the lump sum to the jackpot amount. In the illustrated preferred embodiment the trigger is defined to occur whenever the lump sum reaches or exceeds a threshold value of $20.00. In other embodiments, the trigger is defined to occur when lump sum reaches or exceeds a threshold value that is randomly selected from within a given range. The triggering of the incrementing of the jackpot amount by the lump sum is checked at step 15 by the CPU 2. The first time the $20.00 threshold value is exceeded in the running example is in polling period 9. Hence, it is not triggered for the first 8 polling periods and hence for each of those polling periods the process flow proceeds directly from step 15 to step 18. However, when the CPU performs the comparison at step 15 during polling period 9, it determines that the trigger condition exists (because $22.22 exceeds $20.00) and the process flow proceeds to step 16, at which the variable representing the jackpot amount is incremented by the lump sum. Hence, in contrast to the hitherto steady and progressive accumulation of the jackpot amount, in the running example during polling period 9 the jackpot amount increases suddenly from $32.46 to $55.55. This allows the present method to accumulate the jackpot amount in a manner that has not only the substantially continuous accumulation that is characteristic of the prior art, but which also provides periodic lump sum increases of a quantum that is comparatively larger than the average expected increments during the substantially continuous accumulation phase. This contributes greater volatility, apparent randomness and/or unpredictability to the jackpot accumulation process and gives the players something exciting to look forward to as the jackpot accrues in addition to the eventual awarding of the jackpot.

The addition of the lump sum to the jackpot amount is intended to increase the excitement and drama of the process of jackpot accumulation. For this reason an alert is provided to the participants of the relevant linked EGM's when the jackpot is incremented by the lump sum. The alert includes an audible component, which is played through speakers (not illustrated) and also includes a visual component whereby suitable graphics are shown on the display 7.

The extent to which an average expected value of the lump sum when incremented to the jackpot amount is greater than an average expected value of the first increment can be varied by the entity implementing the linked jackpot. In the running example discussed above, the average expected value of the lump sum when incremented to the jackpot amount is typically at least a factor of ten greater than an average expected value of the first increment. However, this factor may be changed as required. For example, in other embodiments the factor may be at least 100, 1000 or 10,000. It will be appreciated that a higher factor is suitable for implementations in which the lump sum contributions to the jackpot accumulation are desired to be more heavily weighted as compared to the “steady and progressive” contributions to the jackpot accumulation.

After the jackpot amount has been incremented by the lump sum at step 16, the process flow proceeds to step 17 at which the lump sum variable is reset. In the running example, it is reset to $0.00 and then the process flow proceeds to step 18.

At step 18 the CPU 2 determines if an award of the jackpot has been triggered. This may be due to any triggering circumstance as required by the implementers of the invention, however in the preferred embodiment, as mentioned above, an award of the jackpot is triggered when the jackpot amount is equal to, or exceeds the jackpot threshold amount. In the running example, the jackpot threshold amount is $220.00. This amount is not communicated to the players. However, the players are informed that the jackpot amount cannot exceed a maximum jackpot amount, which in the running example is $300.

During polling period 50 the jackpot increases from $213.27 to $235.03 due to a $20.87 lump sum increment. Hence, when the CPU performs the determination at step 18 as to whether the jackpot has been triggered, it determines for polling periods 1 to 49 that no jackpot has been triggered and the process flow loops back to step 12. However, when the CPU performs the determination at step 18 for polling period 50 it determines that a jackpot award has been triggered (because $235.03 exceeds the jackpot threshold amount of $220) and the process flow proceeds to step 19 at which an allocation routine is executed.

The allocation routine at step 19 firstly attempts to award the jackpot to the EGM that contributed the portion of an increment that incremented the jackpot amount to at or above the jackpot threshold amount. This EGM is identified by analyzing the gaming data that was stored in memory 6 and comparing this to the amount of increment was required to trigger the jackpot. In the running example, the jackpot amount was $213.27 after polling period 49. It therefore required an amount of increment to trigger the jackpot of $220-$213.27 (i.e. the threshold jackpot amount minus the previous jackpot amount). That is, it required an increment of $6.73. The first $0.89 of this was covered by the first increment. Hence, the amount of the second increment that was required to trigger the jackpot was $6.73−$0.89=$5.84. The CPU now analyses the stored gaming data to determine which EGM contributed the portion of an increment that made the lump sum equal to or greater than $5.84. It can been seen from the information in FIG. 3 that this occurred during polling period 45 (i.e. when the lump sum increased from $3.96 at the conclusion of polling period 44 to $8.13 at the conclusion of polling period 45). The CPU therefore analyses the gaming data that was stored for polling period 45. In the running example the controller is communicatively linked to a total of ten EGM's, each with a unique identifier consisting of a number between 1 and 10. The gaming data for polling period 45 that is relevant to this determination is shown in columns 1 and 2 of the table below. The third column shows a running total that the CPU calculates as it analyses the gaming data for polling period 45.

| EGM | | |
|---|---|---|
| Identifier | Contribution to Lump Sum | Running Total of Lump Sum |
| 1 | $0.20 | $4.16 |
| 2 | $0.00 | $4.16 |
| 3 | $0.55 | $4.71 |
| 4 | $0.16 | $4.87 |
| 5 | $0.92 | $5.79 |
| 6 | $0.00 | $5.79 |
| 7 | $1.22 | $7.01 |
| 8 | $0.51 | $7.52 |
| 9 | $0.00 | $7.52 |
| 10 | $0.61 | $8.13 |

Hence, the CPU determines that it was EGM No. 7 that contributed the portion of an increment that made the lump sum equal to or greater than $5.84 (because EGM No. 7 contributed the portion {i.e. $1.22} of the lump sum increment that increased the running total of the lump sum from $5.79 to $7.01). Hence, EGM No. 7 is a candidate to receive the jackpot. However, whilst EGM No. 7 was active during polling period 45, there is a possibility that it may have been rendered inactive by the player choosing to cash out from EGM No. 7 in the time between polling period 45 and polling period 50. Hence, the CPU next checks the current playing status of EGM No. 7. If the CPU determines that EGM No. 7 is currently active, then the process flow proceeds to step 20 and the jackpot is awarded to EGM No. 7. However, if the CPU determines that EGM No. 7 is no longer active, then the allocation routine must adopt an alternative strategy to determine an EGM to which to award the jackpot. For the sake of the running example, we shall assume that EGM No. 7 was rendered inactive at some point between polling period 45 and polling period 50. Hence, the allocation routine now utilizes the alternative strategy described below.

To execute the alternative strategy of the allocation routine, the CPU calculates a new jackpot threshold amount that lies within a range defined by the current jackpot amount and the maximum jackpot amount. To do this, the CPU may make use of the methodology disclosed in the Applicant's Australian Patent No. 2008280831, the contents of which are incorporated in their entirety by way of reference. In terms of the running example, the CPU must calculate a new jackpot threshold amount that lies within a range defined by the current jackpot amount as at the end of polling period 50 of $235.03 and the maximum jackpot amount, which in the running example is $300. Hence, the CPU uses a random number generator to select a suitable new jackpot threshold amount, which in the running example shall be $256.45.

The CPU continues to increment the jackpot amount based on the data indicative of gaming activity in the manner discussed above. That is, the CPU continues to calculate first increments, second increments and lump sums for subsequent polling periods and the first increment is added to the jackpot amount for each polling period and the lump sum is added only upon triggering of the lump sum increment trigger. This process continues until the jackpot value is equal to, or greater than $256.45, at which point the CPU makes use of the method described above to determine the EGM that contributed the portion of the increment that incremented the jackpot amount to at or above the new jackpot threshold amount. This EGM then becomes a candidate to receive the jackpot and once again the CPU checks if it is active and only awards the jackpot to that EGM if it is active. If it is inactive, the CPU may, once again, calculate a new jackpot threshold amount that lies within a range defined by the current jackpot amount and the maximum jackpot amount and if necessary this process may be repeated until a winning EGM is determined

Rather than use the above-described technique of calculating a new jackpot threshold amount, another embodiment of the invention makes use of another alternative strategy. In this embodiment, the allocation routine awards the jackpot to the last EGM that contributed a portion of an increment immediately prior to the triggering of the award of the jackpot. The CPU determines this EGM by reviewing the gaming data that was stored in its memory 6 and the jackpot is awarded to that EGM.

As yet another alternative, the allocation routine may award the jackpot to the next EGM to make a contribution subsequent to the triggering of the award of the jackpot. Using this approach, the CPU waits for the gaming data for the next polling period to be reported and, once it has been received, the CPU analyses that data to determine the first EGM to make a contribution. It follows that this EGM must be active (since it has just made a contribution) and the jackpot is awarded to that EGM.

Once the CPU has executed the allocation routine and thereby determined the EGM to which to award the jackpot, the process flow proceeds to step 20 at which the CPU awards the jackpot. Firstly, the jackpot threshold amount is subtracted from the jackpot amount and the result is stored in the memory 6 as a remainder amount. With reference to the running example in which the jackpot amount upon triggering of the jackpot was $235.03 and the jackpot threshold amount was $220 the remainder is $15.03. The CPU then causes a signal to be sent to the EGM that was determined by the allocation routine 19 instructing that EGM to indicate to its player that the jackpot has been won and incrementing the credit meter of that EGM by the jackpot threshold amount, which is $220 in the running example. The process flow then proceeds to step 21, which is the commencement of a new jackpot. Hence, the process flow loops back to step 10. It will be recalled that previously in the running example, the variable representing the jackpot amount was initialised to a base start out value of $25.00. However, for when initializing the second jackpot in this running example, the CPU calculates a start out amount by incrementing a base start up amount of $25.00 by the remainder amount of $15.03. Hence, for the running example the new jackpot is commenced from a start out amount of $40.03 and from here the jackpot proceeds in the manner described above.

In the embodiment described above no indication of the lump sum is displayed to the participants of gaming machines that contribute to the linked jackpot (that is, aside from the sudden increase of the jackpot amount when it is incremented by the lump sum). However, other embodiments provide the participants with an indication of the lump sum via the display 7. This may take the form of a gauge, such as a bar graph for example, that starts out empty and grows in proportion to the lump sum and which is shown as full when the lump sum has been incremented to the threshold. Numeric indications of the amount of the lump sum may be provided along the length of the bar graph, if desired, or the bar graph may be configured so as not to display any scale. Other embodiments provide the players with a non-numeric indication. For example, another embodiment provides the players with a size-based indication of the lump sum consisting of an image of a bag of money, which is displayed at a comparatively small size at the commencement of each accumulation of the lump sum, and which grows in size as the lump sum increases. Another embodiment provides a colour based indication, in which a portion of the display 7 shifts progressively from a first colour, blue, which indicates a low lump sum, to a second colour, red, which is indicative of a higher lump sum. Yet another embodiment provides an indication that is based upon a number of symbols, with the number of symbols increasing as the lump sum increases.

In some embodiments the trigger to increment the jackpot amount by the lump sum varies to that described above. For example, in one embodiment the trigger at step 15 is provided in a signal sent from a player tracking system (not illustrated) to the controller 2. As is well known to those skilled in the art, the player tracking system monitors the gaming activity of a subset of players that have chosen to participate in the tracking scheme. Such players typically identify themselves to the player tracking system via an identification means, such as a card that is inserted into the EGM 4 by the player and which is encoded with an identification number. In one embodiment, the trigger to increment the jackpot amount by the lump sum can only be triggered by the gaming activity of a player that is participating in the player tracking system. When the tracked player's gaming activity fulfils the necessary requirements, such as when the player's contribution to the EGM's turnover equals or exceeds a threshold, for example, the player tracking system sends a signal to the controller 2, which triggers the incrementing of the jackpot amount by the lump sum.

In the above described example, the first multiple of 0.3% was less than the second multiple of 0.8%. This is suitable for implementations wishing to favour the lump sum accumulation of the jackpot amount over the “steady and progressive” accumulation of the jackpot amount. However, it will be appreciated that in other embodiments the first multiple may be greater than the second multiple so as to skew accumulation towards the “steady and progressive” phase at the expense of the lump sum accumulations.

In the embodiment described above the threshold used to trigger incrementing of the jackpot amount by the lump sum is a predefined constant amount of $20.00. However, in other embodiments the threshold is an amount that is randomly determined from within a predefined range (for example, between a minimum of $5 and a maximum of $30). In such an embodiment, a first random determination of the threshold takes place at step 11. Further random determinations of the threshold take place each time the lump sum variable is reset at step 17. This allows the amount of the lump sum that is added to the jackpot amount to vary over successive increments of the lump sum to the jackpot amount, which advantageously provides additional volatility, unpredictability and excitement to the jackpot accumulation process.

Advantageously, some embodiments of the invention may be implemented in a manner that makes effective use of existing linked jackpot systems and processes. Typically only minimal changes are required to reconfigure such existing systems to perform in accordance with the embodiment of the invention. Additionally, many embodiments of the invention require only minimal changes to existing reconciliation and reporting functions that may already be in place in the venues that provide existing linked jackpot systems.

In the embodiment described above the controller 1 is a unit that is physically separate from the linked EGM's and which is dedicated to the running of the linked jackpot. However, in other embodiments the hardware that performs this functionality is disposed within at least one of the EGM's.

As used in this patent specification, including within the claims, the term “jackpot amount” is to be construed broadly so as to include, by way of non-limiting example, a monetary amount and/or an amount of some other instrument of value, such as promotional points, or the like. Additionally, as used in this document, including within the claims, the terms “random”, “randomly”, and the like, are to be construed as connoting either a purely random process or a “pseudo-random” process. An example of a pseudo-random process includes the determination by a computer processor of a pseudo-random number in response to an output of a digital clock.

It will be appreciated by those skilled in the art that the EGM's 4 with which the controller 2 communicates may be any one or combination of: dedicated electronic gaming machines, such as slot machines for example; other electronic devices capable of being programmed to provide the necessary functionality, including computers connected via a communications network such as the internet; hand held devices such as mobile phones, personal digital assistants; and the like.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1. A method of awarding a jackpot in a gaming system in which a jackpot controller is communicatively coupled to a plurality of electronic gaming machines (EGMs), said method including the use of the jackpot controller to:
initialise a variable representing a jackpot amount;
initialise a variable representing a lump sum;
receive a signal including data indicative of gaming activity associated with at least one of the electronic gaming machines;
calculate a first increment in dependence upon said data and increment the variable representing the jackpot amount by the first increment;
calculate a second increment in dependence upon said data and increment the variable representing the lump sum by the second increment;
in response to a trigger that is independent of an award of the jackpot increment the variable representing the jackpot amount by the lump sum; and
determine if an award of the jackpot has been triggered and, if so, execute an allocation routine to determine an EGM to which to award the jackpot.

2. A method according to claim 1 wherein an award of the jackpot is triggered when the jackpot amount equals or exceeds a jackpot threshold amount.

3. A method according to claim 2 wherein the jackpot threshold amount cannot exceed a maximum jackpot amount.

4. A method according to claim 2 wherein each of the electronic gaming machines has a unique identifier and wherein the step of receiving “a signal including data indicative of gaming activity associated with at least one of the electronic gaming machines” includes receiving the unique identifier of each EGM, along with a turnover amount of each of the EGM's within a polling period.

5. A method according to claim 4 further including the step of storing said EGM identifiers and said turnover amounts within a memory accessible by the jackpot controller.

6. A method according to claim 2 wherein the allocation routine awards the jackpot to the EGM that contributed the portion of an increment that incremented the jackpot amount to at or above the jackpot threshold amount.

7. A method according to claim 3 wherein the allocation routine includes the steps of:
calculating a new jackpot threshold amount that lies within a range defined by the current jackpot amount and the maximum jackpot amount;
continuing to increment the jackpot amount based on said data indicative of gaming activity; and
awarding the jackpot to the EGM that contributed the portion of an increment that incremented the jackpot amount to at or above the new jackpot threshold amount.

8. A method according to claim 5 wherein the allocation routine awards the jackpot to the last EGM that contributed a portion of an increment immediately prior to the triggering of the award of the jackpot.

9. A method according to claim 5 wherein the allocation routine awards the jackpot to the next EGM to make a contribution subsequent to the triggering of the award of the jackpot.

10. A method according to claim 2 wherein awarding of the jackpot includes the steps of:
subtracting the jackpot threshold amount from the jackpot amount and storing the result as a remainder amount;
awarding the jackpot threshold amount to an EGM; and
calculating a start out amount by incrementing a base start up amount by the remainder; and
commencing accumulating a new jackpot amount from the start out amount.

11. A jackpot controller communicatively coupled to a plurality of electronic gaming machines, said jackpot controller being configured so as to perform a method as defined in claim 1.
